(19) United States
(12) Patent Application Publication
(10) Pub. No.: US 2024/0386309 A1
(43) Pub. Date: Nov. 21, 2024

(54) DECENTRALIZED DATA MAP FROM THE POINT OF VIEW OF A DATA ACCESSOR

(71) Applicant: Bank of America Corporation, Charlotte, NC (US)

(72) Inventors: Napur Gupta, London (GB); Harinath Meedinti Bhaskara Reddy, Charlotte, NC (US); Manu Kurian, Dallas, TX (US)

(21) Appl. No.: 18/198,985

(22) Filed: May 18, 2023

(51) Int. Cl. G06N 20/00

(52) U.S. Cl. CPC G06N 20/00

(57) ABSTRACT

A system and method for providing a customized response for data by creating and applying a multi-layered data map. Methods may include configuring a computer processor located in a data mesh to implement machine learning systems for identifying the content of data distributed across data storage units, determining the credentials required to access the data, identifying the locations of the data, and identifying points of interest within the data. Methods may include a machine learning system for populating a data map with the preceding information. Methods may include receiving a request for data from an accessor presenting their credentials. Methods may include consulting with the multi-layer data map and presenting information to the accessor which contains the requested data according to the accessor's credentials, the locations of the data, the level of sensitivity associated with the data, and/or points of interest within the data.

### FIELD OF TECHNOLOGY

Aspects of the disclosure relate to retrieval of data. Specifically, aspects of the disclosure relate to data maps for retrieval of data.

### BACKGROUND OF THE DISCLOSURE

Data may be stored in an organization in a centralized manner, a decentralized manner, or a combination of both. Data may be stored in one location or across multiple locations in an organization. The latter may be due to intension or undesired storage redundancy.

Some data such as decentralized treasury applications, may be processed in individual, disparate, highly-resource consumptive, legacy formats.

It would be desirable to have access to the disparate data in a time and resource-efficient manner.

It would also be desirable to present the disparate data in a way that is useful for accessor of the data.

### SUMMARY OF THE DISCLOSURE

It may be an object of the invention to use a data mesh to provide an overall view of disparate data in a time and resource-efficient manner.

It may also be an object of the invention to use artificial intelligence and/or machine learning systems to provide an overall view to data from a vantage point of a data accessor or other node.

It may further be an object of the invention to provide a layered data map that may apply various filters to the data depending on the data accessor. For example, a consumer accessing the data may desire a functional view of the data map, and a back-end operator may desire a storage view of the data map. Some data in the data mesh may be available to all accessors. Some data in the data mesh may only be available to some accessors, such as accessors that present pre-determined credentials.

Apparatus and methods are herein provided to meet the above outlined objectives of the invention.

Aspects of the disclosure may relate to apparatus and methods for providing a customized response to a request for data by creating and applying a multi-layered data map. For example, a consumer accessing the data may desire a functional view of the data map, and a back-end operator may desire a storage view of the data map.

Methods may include configuring a computer processor located in a data mesh to implement one or more of the following artificial intelligence and/or machine learning systems.

Methods may include a machine learning system for identifying the content of sets of data distributed across data storage units in electronic communication with the data mesh. For each set of data, methods may include a machine learning system for determining the level of sensitivity of the set of data and the credentials required to access the sensitive set of data.

Methods may include a machine learning system for identifying the locations of the sets of data distributed across the data storage units.

Methods may include a machine learning system for identifying points of interest within sets of data, where the points of interest are pieces of data that have been identified by the machine learning system to have a higher probability of recognition by a user than other data in the data sets besides the points of interest.

Methods may include a machine learning system for populating a data map with i) the content of the sets of data, ii) the locations of the sets of data, iii) the level of sensitivity associated with the sets of data, and/or iv) points of interest within the sets of data.

Methods may include receiving a request for data, where the request meets pre-determined criteria, from an accessor using a user device who presents one or more credentials. Methods may further include a machine learning system for consulting with the data map for the purpose of i) identifying data from the sets of data distributed across the data storage units which meet the criteria for the request for data, ii) determining which of the identified data are at a level of sensitivity permitted to be shared with the accessor based on the presented credentials, iii) associating locations with the identified data which are permitted to be shared with the accessor, and iv) associating points of interest with the identified data which are permitted to be shared with the accessor.

Methods may include a machine learning system providing the accessor with i) the identified data which are permitted to be shared with the accessor, ii) the locations of the data within the data storage units, and iii) the points of interest associated with the data.

Methods may include the machine learning systems being deep learning systems.

Methods may include presenting data from the viewpoint of a consumer.

Methods may include presenting data from the viewpoint of a back-end operator of an organization.

Methods may include presenting data from the viewpoint of a sales representative of an organization.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative block diagram in accordance with principles of the disclosure;

FIG. 2 shows an illustrative block diagram in accordance with principles of the disclosure;

FIG. 3 shows an illustrative block diagram in accordance with principles of the disclosure;

FIG. 4 shows an illustrative block diagram in accordance with principles of the disclosure; and

FIG. 5 shows an illustrative flowchart in accordance with principles of the disclosure.

### DETAILED DESCRIPTION OF THE DISCLOSURE

Aspects of the disclosure may relate to apparatus and methods for providing a customized response to a request for data by creating and applying a multi-layered data map.

Apparatus may include a system for providing a customized response to a request for data by creating and applying a multi-layered data map.

Apparatus may include a data mesh. Apparatus may include a computer processor located in the data mesh. Apparatus may include data storage units in electronic communication with the data mesh, where sets of data are stored in the data storage units. Apparatus may include user devices in electronic communication with the data mesh. Apparatus may include a data map in electronic communication with the data mesh.

A data mesh may not centralize data in one location. A data mesh may keep data at multiple data storage units throughout the data mesh.

A data mesh may provide an overall view of the data from the vantage point of a data accessor or other node. For example, the data mesh may run a machine learning system to present data from a viewpoint of a consumer. The data mesh may run a machine learning system to present data from the viewpoint of a back-end operator. The data mesh may run a machine learning system to present data from the viewpoint of a sales representative. Thus, the data mesh running machine learning systems may create a multi-layer data map that provides flexibility to present, for example, the above-mentioned viewpoints.

Each location of the data may have a native processing protocol which may be made known and available to a data accessor. The data may have a drill down to various levels of data. Some data may be accessible to all accessors. Some data may only be accessible to some data accessors. Accessibility may be controlled by requiring certificates from a user device.

Apparatus may include the computer processor configured to implement artificial intelligence systems. Apparatus may include the computer processor configured to implement machine learning systems.

Apparatus may include a machine learning system to identify content of sets of data distributed across the data storage units. For each set of data, apparatus may include a machine learning system to determine the level of sensitivity of the set of data and the credentials required to access a sensitive set of data. Sensitive data may refer to data that is confidential. Sensitive data may refer to data to which the data owner restricts access.

Apparatus may include a machine learning system to identify locations where the sets of data are distributed across the data storage units.

Apparatus may include a machine learning system to identify points of interest within the sets of data, where the points of interest are pieces of data that have been identified by the machine learning system to have a higher probability of recognition by a user than other data in the data sets besides the points of interest.

Apparatus may include a machine learning system that populates a data map with i) the content of the sets of data, ii) the locations of the sets of data, iii) the level of sensitivity associated with the sets of data, and/or iv) points of interest within the sets of data.

Apparatus may include a machine learning system to receive a request for data, where the request meets pre-determined criteria, from an accessor using a user device who presents credentials. Apparatus may further include a machine learning system which consults with the data map to i) identify data from the sets of data distributed across the data storage units which meet the criteria for the request for data, ii) determine which of the identified data are at a level of sensitivity permitted to be shared with the accessor based on the presented credentials, iii) associate locations with the identified data which are permitted to be shared with the accessor, and iv) associate points of interest with the identified data which are permitted to be shared with the accessor.

Apparatus may include a machine learning system to provide the accessor with i) the identified data which are permitted to be shared with the accessor, ii) the locations of the data within the data storage units, and iii) the points of interest associated with the data.

Apparatus may include the machine learning systems being deep learning systems.

Apparatus may include the machine learning systems being artificial intelligence systems.

Apparatus may include a machine learning system which presents data from a consumer's viewpoint.

Apparatus may include a machine learning system which presents data from a viewpoint of a back-end operator of an organization.

Apparatus may include a machine learning system which presents data from the viewpoint of a sales representative of an organization.

Further aspects of the disclosure may relate to apparatus and methods for sharing sensitive data with an accessor at a level corresponding to the accessor's credentials in a manner that may minimize risk of unapproved, uncredentialed, and/or under credentialed access to sensitive data. To provide the sensitive data, the apparatus and methods may employ a system for providing a customized response to a request for sensitive data by creating and applying a multi-layered data map.

Apparatus may include a system for sharing sensitive data stored in data storage units across a data mesh in a manner that may minimize risk of unapproved, uncredentialed, and/or under credentialed access to data.

Apparatus may include a data mesh. Apparatus may include a data orchestrator operating in the data mesh. Apparatus may include data storage units located in the data mesh in electronic communication with the data orchestrator. Apparatus may include controllers located in the data mesh in electronic communication with the data orchestrator and the data storage units. Apparatus may include user devices in the data mesh in electronic communication with the data orchestrator. An accessor may utilize a user device to interact with the data orchestrator.

A user device may be a computer processor. A user device may be a computer. A user device may be an edge computing device. A user device may be a personal computer.

Apparatus may include a data map in electronic communication with the data orchestrator. The data map may be populated to contain i) a content of sets of data, ii) locations of the sets of data, iii) a level of sensitivity associated with the sets of data, and/or iv) points of interest within the sets of data. The data map may be populated by the data orchestrator using machine learning systems. The data map may be populated by a computer processor running on the data mesh using machine learning systems.

The data orchestrator may be configured to implement machine learning systems. The data orchestrator may be configured to implement artificial intelligence systems. The data orchestrator may include a computer processor running it. The computer processor may also be running in the data mesh. The data orchestrator may be a computer processor. The computer processor may also be running in the data mesh. The data orchestrator may include a machine learning system operating on it. In the following description of the system, the data orchestrator may include an artificial intelligence system operating on it. In the following description of the system, the computer processor running on the data mesh may include a machine learning system operating on it.

A computer processor may implement multiple machine learning systems on the data orchestrator. A computer processor may use a machine learning system to create a usage model for the system's users. The machine learning system may determine if there is an inappropriate use by a particular user which may indicate an impostor attempting to access or accessing the user's account or misappropriation by the user of the user's login credentials.

A computer processor may implement a machine learning system that involves, for example, an accessor who lacks sufficient credentials to retrieve sensitive data which is required by the accessor. For example, the accessor may require sensitive data to power a data model. In such a case, or another similar case, the machine learning system may replace the sensitive data in a way that provides the information in an anonymous way to power the data model without exposing the sensitive data. Alternatively, the machine learning system may aggregate the sensitive data in a way that provides the information in an anonymous way to power the data model without exposing the sensitive data.

A computer processor may implement a machine learning system that involves segmenting the data stored in the system. By reducing data storage redundancy and having a mixed data storage scheme, the risk of a data breach may be lessened. An unauthorized retrieval may yield limited data. Furthermore, other risk reduction measures discussed herein may further reduce potential risk of sensitive data leakage due to an unauthorized data breach.

A computer processor may implement a machine learning system to mine sensitive data found in data storage units across a data mesh. The machine learning system could determine where sensitive data is stored throughout the data mesh, allowing for rapid retrieval.

A computer processor may implement a machine learning system to identify content of data, for example, one or more sets of data distributed across data storage units. For each set of data, apparatus may include a machine learning system to determine the level of sensitivity of the set of data and the credentials required to access a sensitive set of data. Sensitive data may refer to data that is confidential. Sensitive data may refer to data to which the data owner restricts access.

A computer processor may implement a machine learning system to identify locations where the sets of data are distributed across the data storage units.

A computer processor may implement a machine learning system to identify points of interest within the sets of data, where the points of interest are pieces of data that have been identified by the machine learning system to have a higher probability of recognition by an accessor than other data in the data sets besides the points of interest.

A computer processor may include a machine learning system that populates a data map with i) the content of the sets of data, ii) the locations of the sets of data, iii) the level of sensitivity associated with the sets of data, and/or iv) points of interest within the sets of data.

A computer processor may implement a machine learning system to receive a request for data, where the request meets pre-determined criteria, from an accessor using a user device who presents credentials. Apparatus may further include a machine learning system which consults with the data map to i) identify data from the sets of data distributed across the data storage units which meet the criteria for the request for data, ii) determine which of the identified data are at a level of sensitivity permitted to be shared with the accessor based on the presented credentials, iii) associate locations with the identified data which are permitted to be shared with the accessor, and/or iv) associate points of interest with the identified data which are permitted to be shared with the accessor.

A computer processor may implement a machine learning system to provide the accessor with i) the identified data which are permitted to be shared with the accessor, ii) the locations of the data within the data storage units, and/or iii) the points of interest associated with the data.

A computer processor may implement a machine learning system that may be implemented in a model to protect the sensitive data from undesired access, for example, from an intruder or from a user who lacks sufficient credentials to access a particular set of sensitive data. For example, the computer processor may implement a machine learning system where the sensitive data in the data storage units is in a dormant state until being called upon by a user with sufficient credentials. The data storage unit may be awoken for the data's access duration. When access to the data is no longer needed, the data storage unit may revert to a dormant state. This may include using a data orchestrator to provide a dynamic level to the sensitive data, for example, to provide a credentialed user with access to the sensitive data, and then take it away the access when the credentialed user no longer needs access to the sensitive data.

A further aspect to the machine learning system involving awaking dormant data storage may include tokenizing and/or encrypting the data. For example, the data orchestrator may control access to the data by creating a token or key in the metadata of the data. Access to the data may necessitate possession of the token or key. Alternatively, or complementary, a controller may require a pre-authorization token or pre-authorization key to proceed with requesting access to the data storage unit. The pre-authorization token or key may provide another level of protection to the data in the data storage unit. Access may be granted to a user device, for example, only when presenting a valid pre-authorization token or key. However, when no valid user device is presenting a pre-authorization key, the connection to the data storage unit may be shut down. When data is requested, the data storage unit may be woken up for use, but the data storage unit may be maintained in a dormant state. Furthermore, the pre-authorization token or key, together with the token or key in the metadata of the data, may complement each other in creating an even higher level of security to the data. In addition, requiring a separate token or key from a user and the user's device may add one or more additional levels are security.

A computer processor may implement a machine learning system that responds to a duress state. For example, if the controller is hacked, the machine learning system may detect the hack and create a duress state. The same or different machine learning system may respond to hack by presenting access to an empty data storage. The same or different machine learning system may respond to hack by presenting access to a data storage containing data that is not accurate and/or does not contain sensitive information.

The apparatus may include a system that uses a multi-layered data map to identify and share sensitive data stored in a data mesh which minimizes risk of unapproved access to sensitive data.

The apparatus may include a data mesh. The apparatus may include a data orchestrator located in the data mesh, where the data orchestrator contains a computer processor. The apparatus may include data storage units located in the data mesh and in electronic communication with the data orchestrator, where the sets of data are stored in the data storage units, and the data storage units are kept in a dormant state.

The apparatus may include controllers located in the data mesh and in electronic communication with the data orchestrator and the data storage units. The apparatus may include user devices located in the data mesh and in electronic communication with the data orchestrator. The apparatus may include a data map located in the data mesh and in electronic communication with the data orchestrator.

The apparatus may include where the data orchestrator is configured to implement one or more machine learning systems to perform the following functions: Identify the content of the sets of data distributed across the data storage units; Identify a pre-determined level of sensitivity for the sets of data, wherein the pre-determined level of sensitivity indicates what credentials are required to access the sets of data; Identify locations where the sets of data are distributed across the data storage units; Identify points of interest within the sets of data, wherein the points of interest are pieces of data that have been pre-determined to have a higher probability of recognition by an accessor than data in the sets of data other than the points of interest; and/or, Populate the data map with the content of the sets of data, the pre-determined level of sensitivity for the sets of data, the locations of the sets of data, and the points of interest within the sets of data.

The data orchestrator may be further configured to implement one or more machine learning systems to perform the following functions. When the data orchestrator receives a request for sets of data from an accessor, the data orchestrator may i) receive credentials from the accessor; ii) look up in the data map to find one or more sets of data that meet the request from the accessor and which are permitted to be shared based on the credentials from the accessor; iii) provide the credentials from the accessor to the controllers positioned between the data orchestrator and the data storage units; iv) receive clearance from the controllers to access the data storage units, wherein the controllers wakes up the data storage units from the dormant state; and/or v) provide the credentials from the accessor to the data storage units.

The apparatus may include, in response to the request for sets of data from the accessor, provide the accessor with the identified sets of data which are permitted to be shared based on the accessor's credentials, the locations associated with the sets of data, and/or the points of interest associated with the one or more sets of data.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

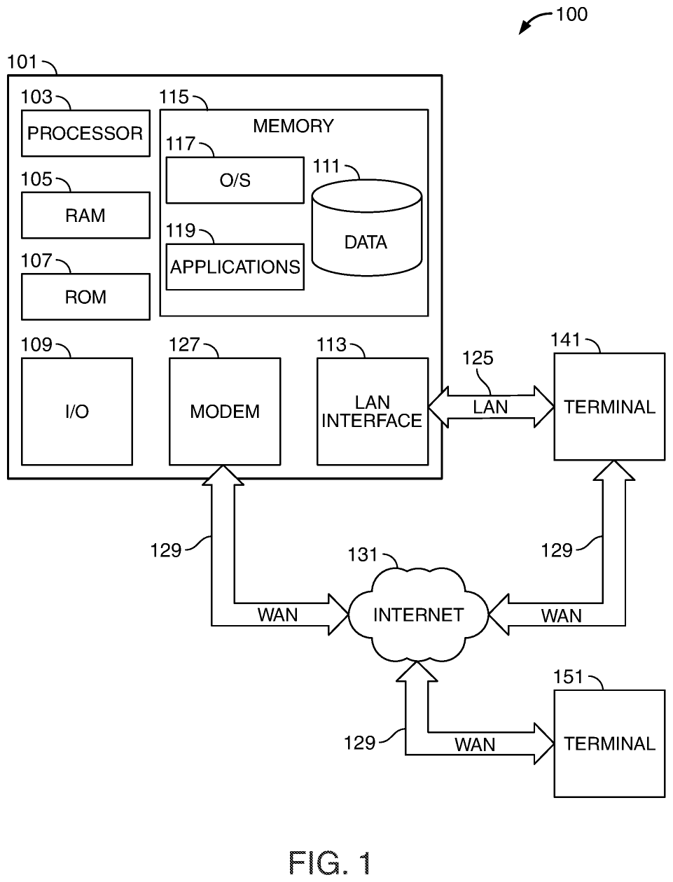

FIG. 1 shows an illustrative block diagram of system 100 that includes computer 101. One may refer to Computer 101 as an “engine,” “server” or “computing device.” Computer 101 may be a workstation, desktop, laptop, tablet, smart phone, or any other suitable computing device. One may use elements of system 100, including computer 101, to implement various aspects of the systems and methods disclosed herein.

Computer 101 may have processor 103 for controlling operation of the device and its associated components, and may include RAM 105, ROM 107, input/output module 109, and non-transitory/non-volatile machine-readable/writeable memory 115. One may configure machine-readable/writeable memory to store information in machine-readable/writeable data structures. Processor 103 may also execute all software running on the computer—e.g., an operating system and/or voice recognition software. Other components commonly used for computers, such as EEPROM or Flash memory or any other suitable components, may also be part of computer 101.

Memory 115 may be comprised of any suitable permanent storage technology—e.g., a hard drive. Memory 115 may store software including operating system 117 and application program(s) 119 along with any data 111 needed for operation of system 100. Memory 115 may also store videos, text, and/or audio assistance files. One may store data in memory 115, in cache memory, or in any other suitable memory.

Input/output (“I/O”) module 109 may include connectivity to a microphone, keyboard, touch screen, mouse, and/or stylus. One may provide input into computer 101 through these I/O modules. The input may include input relating to cursor movement. I/O 109 may also include one or more speakers for providing audio output and a video display device for providing textual, audio, audiovisual, and/or graphical output. The input and/or output may be related to computer application functionality.

One may connect System 100 to other systems via local area network (LAN) interface (or adapter) 113. System 100 may operate in a networked environment supporting connections to one or more remote computers, such as terminals 141 and 151. Terminals 141 and 151 may be personal computers or servers that include many or all the elements described above relative to system 100. Network connections depicted in FIG. 1 include a local area network (LAN) 125 and a wide area network (WAN) 129 but may also include other networks. One may connect computer 101 to LAN 125 through LAN interface (or adapter) 113 when using a LAN networking environment. When used in a WAN networking environment, computer 101 may include modem 127 or other means for establishing communications over WAN 129, such as Internet 131.

One appreciates that the network connections shown are illustrative. One may use other means of establishing a communications link between computers. One may presume the existence of various well-known protocols such as TCP/IP, Ethernet, FTP, HTTP, and the like. One may operate the system in a client-server configuration to permit retrieval of data from a web-based server or application programming interface (API). One may understand that web-based, for this application, includes a cloud-based system. The web-based server may transmit data to any other suitable computer system. The web-based server may also send computer-readable instructions, together with data, to any suitable computer system. The computer-readable instructions may be to store data in cache memory, the hard drive, secondary memory, or any other suitable memory.

Additionally, one may use application program(s) 119 on computer 101.

These programs may include computer executable instructions for invoking functionality related to communication, such as e-mail, Short Message Service (SMS), and voice input and speech recognition applications. One may refer to application program(s) 119 (alternatively, “plugins,” “applications,” or “apps”) to include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for the processing of calls received from calling sources as detailed herein.

Application program(s) 119 may include computer executable instructions (alternatively referred to as “programs”). Embodied in hardware or firmware (not shown) may be the computer executable instructions. Computer 101 may execute the instructions embodied by the application program(s) 119 to perform various functions.

Application program(s) 119 may utilize the computer-executable instructions executed by a processor. Programs include routines, programs, objects, components, data structures, etc. that perform tasks or implement abstract data types. A computing system may be operational with distributed computing environments. Remote processing may perform tasks on devices linked through a communications network. In a distributed computing environment, a program may be in both local and remote computer storage media including memory storage devices. Computing systems may rely on a network of remote servers hosted on the Internet to store, manage, and process data (e.g., “cloud computing” and/or “fog computing”).

Stored in memory 115 is any information described above in connection with database 111, and any other suitable information. One or more of application program(s) 119 may include one or more algorithms used to create and apply a multi-layered data map. One or more of application program(s) 119 may include one or more algorithms used to provide a customized response to a request for data by creating and applying a multi-layered data map. One or more of application program(s) 119 may include a machine learning system may determine if there is an inappropriate use by a particular user which may indicate an impostor attempting to access or accessing the user's account or misappropriation by the user of the user's login credentials.

One may describe the invention in the context of computer-executable instructions, such as application program(s) 119, for execution by a computer. Programs may include routines, programs, objects, components, and data structures, which perform tasks or implement data types. One may practice the invention in distributed computing environments. One may perform tasks by remote processing devices, linked through a communications network. In a distributed computing environment, programs may be in both local and remote computer storage media including memory storage devices. One may consider such programs, for this application's purposes, as engines for the performance of the program-assigned tasks.

Computer 101 and/or terminals 141 and 151 may also include various other components, such as a battery, speaker, and/or antennas (not shown). One may link components of computer system 101 by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

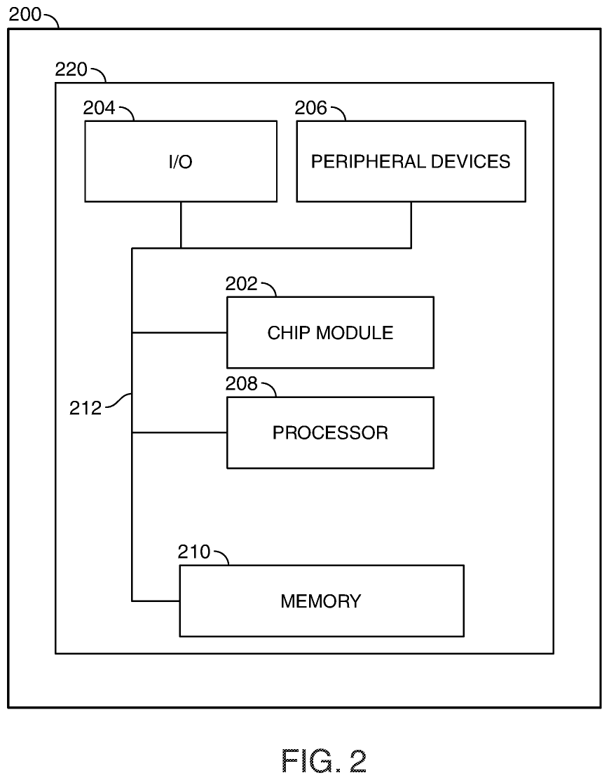

FIG. 2 shows an illustrative block diagram of apparatus 200. One may configure apparatus 200 in accordance with the principles of the disclosure. Apparatus 200 may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real time timers, power-on reset generators or any other suitable peripheral devices; logical processing device 208, which may compute data structural information and structural parameters of data; and machine-readable/writeable memory 210.

One may configure machine-readable/writeable memory 210 to store information in machine-readable/writeable data structures, such as: machine executable instructions (for example, “computer instructions” or “computer code”); applications, signals; and/or any other suitable information or data structures.

One may couple together components 202, 204, 206, 208 and 210 by system bus (or other interconnections) 212 and may be present on one or more than one circuit board 220. In some embodiments, the components may be integrated into a single chip. The chip may be silicon-based.

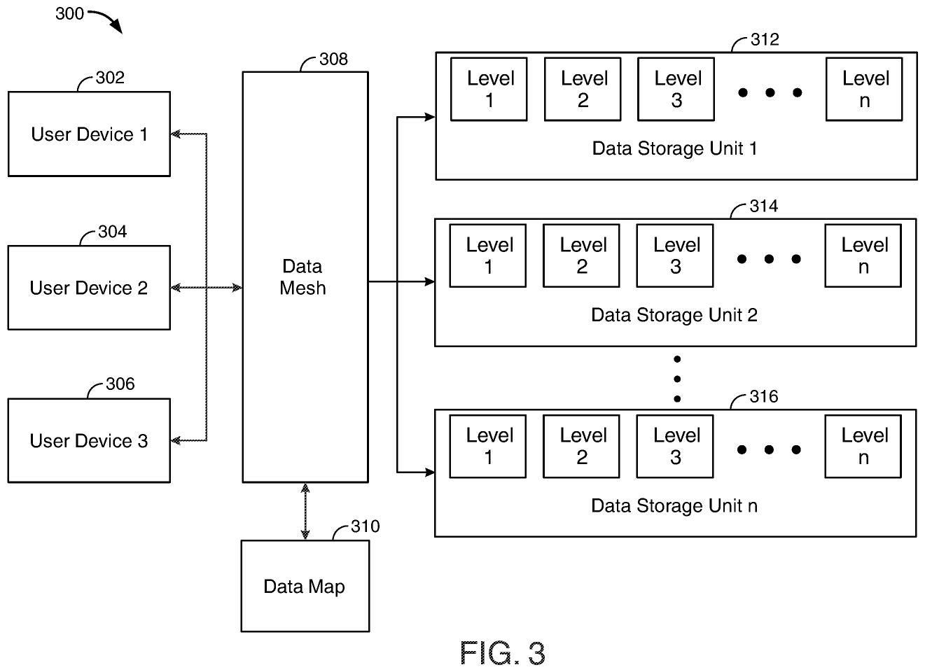

FIG. 3 shows an illustrative diagram 300. User device 1 302, user device 2 304, and user device 3 306 may have two-way communication with a data mesh 308. Each user device may request data and/or transmit data to be stored. The data mesh 308 may provide data to one of the user devices and/or receive a data request from a user device. The data mesh 308 may communicate with the data map 310 to determine data which is permitted to be shared with a user device, the location of the data in the data storage units, and pointers of interest associated with the data.

Data mesh 308 may communicate with data storage unit 1 312, data storage unit 2 314, and/or data storage unit n 316. Data storage unit n 316 may indicate that any number of data storage units may be included in 300 and in communication with the data mesh 308. Each data storage unit may have distinct levels, for example, level 1, level 2, level 3, going up to level n. Level n indicates that any number of levels may be included in a data storage unit. A level may be associated with a specific degree of sensitivity of data. A user device may present credentials which enable the user device to access pre-determined levels within a data storage unit, but not other levels.

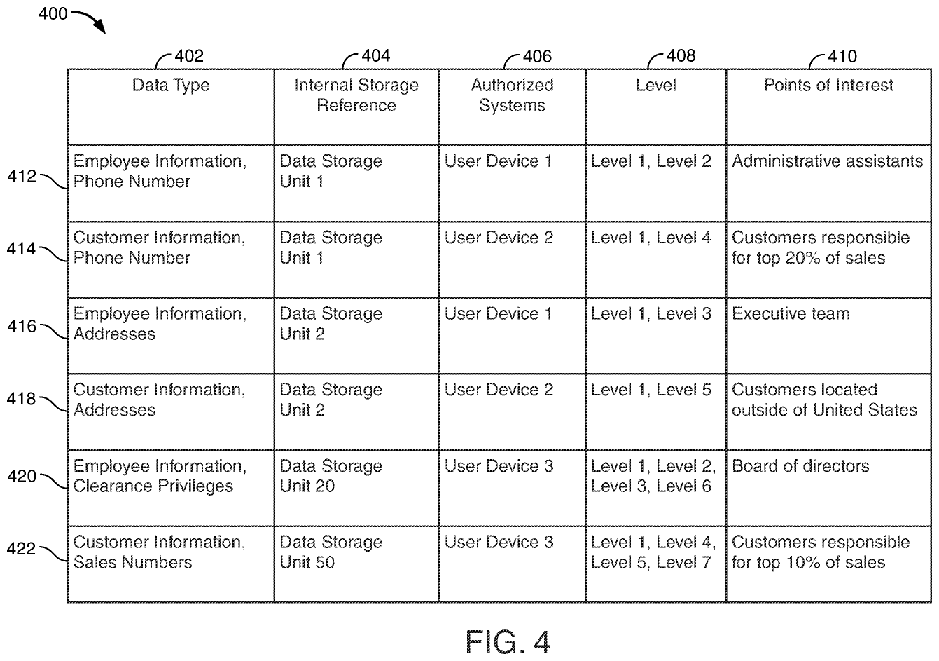

FIG. 4 shows an illustrative diagram 400 which may represent a data map. Column 402 may show data type. Data type may include employee information—phone number; customer information—phone number; employee information—addresses; customer information—addresses; employee information—clearance privileges; and/or customer information—sales numbers. Column 404 may show an internal storage reference. Data may be stored on data storage unit 1, data storage unit 2, data storage unit 20, data storage unit 50, and/or any other data storage unit. There may be, as well, many more or many less data storage units than 50. Column 406 may show authorized systems that may access some of the data stored in the data mesh, for example, data stored at data storage units. Authorized systems may be user device 1, user device 2, user device 3, and/or other user devices. Level 408 may show a degree of clearance granted to a user device that may possess pre-determined credentials. For example, level 1, level 2, level 3, level 4, level 5, level 6, level 7, and/or other levels. Points of interest 410 may show data that may be more wanted or more well known than other data in the internal storage reference. For example, points of interest may include data regarding administrative assistants such as their phone numbers, customers responsible for the top 20% of sales such as their phone numbers, the executive team such as their addresses, customer locations such as those located out of the United States, board of directors such as their clearance privileges, and customers responsible for the top 10% of sales.

Row 412 may show an example of employee information—phone number. When the data is stored, in whole or in part, in data storage unit 1 and is being accessed by user device 1 with user device 1's credentials, permitted levels of access may be level 1 and level 2. Points of interest identified in the data type may be the phone numbers of the organization's administrative assistants.

Row 414 may show an example of customer information—phone number. When the data is stored, in whole or in part, in data storage unit 1 and is being accessed by user device 2 with user device 2's credentials, permitted levels of access may be level 1 and level 4. Points of interest identified in the data type may be the customers responsible for the top 20% of sales.

Row 416 may show an example of employee information—addresses. When the data is stored, in whole or in part, in data storage unit 2 and is being accessed by user device 1 with user device 1's credentials, permitted levels of access may be level 1 and level 3. Points of interest identified in the data type may be the addresses for the organization's executive team.

Row 418 may show an example of customer information—addresses. When the data is stored, in whole or in part, in data storage unit 2 and is being accessed by user device 2 with user device 2's credentials, permitted levels of access may be level 1 and level 5. Points of interest identified in the data type may be the addresses of customers located outside of the United States.

Row 420 may show an example of employee information—clearance privileges. When the data is stored, in whole or in part, in data storage unit 20 and is being accessed by user device 3 with user device 3's credentials, permitted levels of access may be level 1, level 2, level 3, and level 6. Points of interest identified in the data type may be the clearance privileges of the organization's board of directors.

Row 422 may show an example of customer information—sales numbers. When the data is stored, in whole or in part, in data storage unit 50 and is being accessed by user device 3 with user device 3's credentials, permitted levels of access may be level 1, level 4, level 5, and level 7. Points of interest identified in the data type may be the customers responsible for the top 10% of sales.

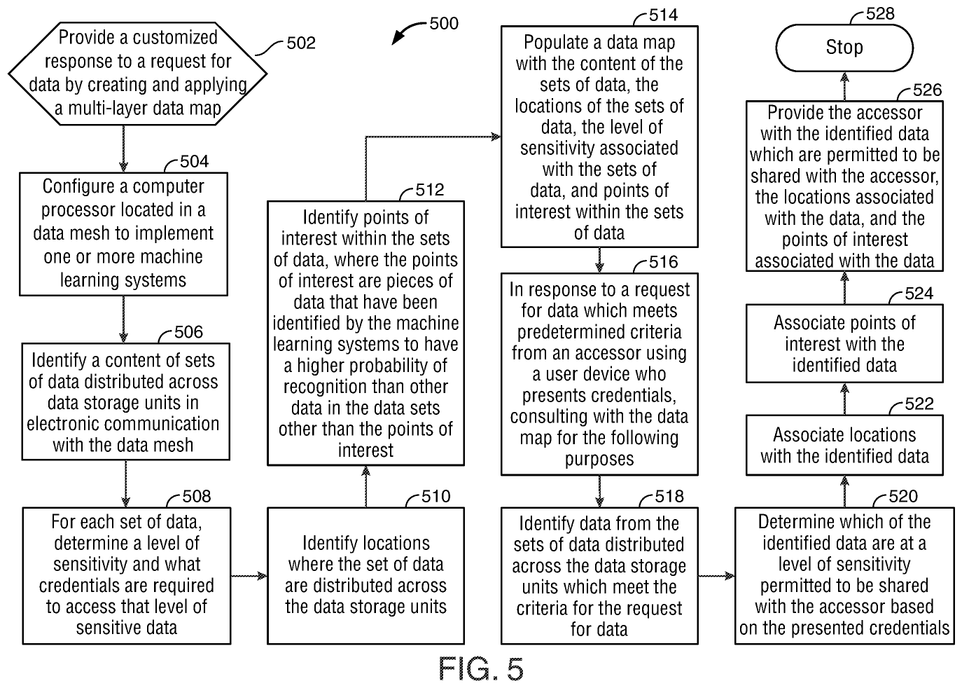

FIG. 5 shows an illustrative flowchart 500. The flowchart starts at 502 and may present a method for providing a customized response to a request for data by creating and applying a multi-layer data map. At step 504, a computer processor located in a data mesh may be configured to implement one or more machine learning systems. At step 506, a machine learning system may identify a content of sets of data distributed across data storage units in electronic communication with the data mesh. At step 508, for each set of data, a machine learning system may determine a level of sensitivity and what credentials are required to access that level of sensitive data.

At step 510, a machine learning system may identify locations where the sets of data are distributed across the data storage units. At step 512, a machine learning system may identify points of interest within the sets of data, where the points of interest are pieces of data that have been identified by the machine learning systems to have a higher probability of recognition than other data in the data sets other than the points of interest. At step 514, a machine learning system may populate a data map with the content of the sets of data, the locations of the sets of data, the level of sensitivity associated with each of the sets of data, and points of interest within the sets of data.

In response to a request for data which meets pre-determined criteria from an accessor using a user device who presents credentials, at step 516, a machine learning system may consult with the data map as described in the following steps. At step 518, a machine learning system may identify data from the sets of data distributed across the data storage units which meet the criteria for the request for data. At step 520, a machine learning system may determine which of the identified data are at a level of sensitivity permitted to be shared with the accessor based on the presented credentials. At step 522, a machine learning system may associate locations with the identified data, where the identified data are permitted to be shared with the accessor. At step 524, a machine learning system may associate points of interest with the identified data, where the identified data are permitted to be shared with the accessor.

At step 526, a machine learning system may provide the accessor with the identified data permitted to be shared with them, the locations associated with them, and the points of interest associated with the data. At step 528, a machine learning system may stop the method as the method may be completed.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for a decentralized data map from the point of view of a data accessor are provided. Persons skilled in the art will appreciate that the present invention can be practiced by other than the described embodiments, which are presented for purposes of illustration rather than of limitation, and that the present invention is limited only by the claims that follow.

What is claimed is:

1. A multi-layered data map in a data mesh, comprising:
a data mesh;
a computer processor located in the data mesh;
one or more data storage units in electronic communication with the data mesh, wherein one or more sets of data are stored in the one or more data storage units;
one or more user devices in electronic communication with the data mesh;
a data map in electronic communication with the data mesh;
wherein the computer processor is configured to implement one or more machine learning systems to:
identify a content of the one or more sets of data distributed across the one or more data storage units;
for each set of data of the one or more sets of data, determine a level of sensitivity, wherein to access a set of data with a pre-determined level of sensitivity, one or more credentials are required;
identify one or more locations where the one or more sets of data are distributed across the one or more data storage units;
identify one or more points of interest within the one or more sets of data, wherein the one or more points of interest are one or more pieces of data and have been identified by the one or more machine learning systems to have a higher probability of recognition by an accessor than data in the one or more data sets other than the one or more points of interest;
populate the data map with the content of the one or more sets of data, the one or more locations of the one or more sets of data, the level of sensitivity associated with each of the one or more sets of data, and one or more points of interest within the one or more sets of data;
in response to a request for data which meets pre-determined criteria from an accessor using a user device who presents one or more credentials, consult with the data map to:
identify data from the one or more sets of data distributed across the one or more data storage units which meet the criteria for the request for data;
determine which of the identified data are at a level of sensitivity permitted to be shared with the accessor based on the presented one or more credentials;
identify one or more locations associated with the identified data which are permitted to be shared with the accessor; and
identify one or more points of interest associated with the identified data which are permitted to be shared with the accessor; and
provide the accessor with the identified data which are permitted to be shared with the accessor, the one or more locations associated with the data, and the one or more points of interest associated with the data.

2. The system of claim 1, wherein the one or more machine learning systems are deep learning systems.

3. The system of claim 1, wherein the one or more machine learning systems are artificial intelligence systems.

4. The system of claim 1, wherein the one or more machine learning systems present data from a viewpoint of a consumer.

5. The system of claim 1, wherein the one or more machine learning systems present data from a viewpoint of a back-end operator.

6. The system of claim 1, wherein the one or more machine learning systems present data from a viewpoint of a sales representative.

7. A method of providing a customized response to a request for data by creating and applying a multi-layered data map, comprising:
configuring a computer processor located in a data mesh to implement one or more machine learning systems for:
identifying a content of one of more sets of data distributed across one or more data storage units in electronic communication with the data mesh;
for each set of data of the one or more sets of data, determining a level of sensitivity, wherein to access a set of data with a pre-determined level of sensitivity, one or more credentials are required;
identifying one or more locations where the one or more sets of data are distributed across the one or more data storage units;
identifying one or more points of interest within the one or more sets of data, wherein the one or more points of interest are one or more pieces of data and have been identified by the one or more machine learning systems to have a higher probability of recognition than other data in the one or more data sets other than the one or more points of interest;
populating a data map with the content of the one or more sets of data, the one or more locations of the one or more sets of data, the level of sensitivity associated with each of the one or more sets of data, and one or more points of interest within the one or more sets of data;
in response to a request for data which meets pre-determined criteria from an accessor using a user device who presents one or more credentials, consulting with the data map for the purpose of:
identifying data from the one or more sets of data distributed across the one or more data storage units which meet the criteria for the request for data;
determining which of the identified data are at a level of sensitivity permitted to be shared with the accessor based on the presented credentials;
associating one or more locations with the identified data which are permitted to be shared with the accessor; and
associating one or more points of interest with the identified data which are permitted to be shared with the accessor; and
providing the accessor with the identified data which are permitted to be shared with the accessor, the one or more locations associated with the data, and the one or more points of interest associated with the data.

8. The method of claim 7, wherein the one or more machine learning systems are deep learning systems.

9. The method of claim 7, wherein the one or more machine learning systems are artificial intelligence systems.

10. The method of claim 7, wherein the one or more machine learning systems present data from a viewpoint of a consumer.

11. The method of claim 7, wherein the one or more machine learning systems present data from a viewpoint of a back-end operator.

12. The method of claim 7, wherein the one or more machine learning systems present data from a viewpoint of a sales representative.

13. A system that uses a multi-layered data map to identify and share sensitive data stored in a data mesh which minimizes risk of unapproved access to sensitive data, comprising:
a data mesh;
a data orchestrator located in the data mesh, the data orchestrator comprising a computer processor;
one or more data storage units located in the data mesh and in electronic communication with the data orchestrator, wherein:
one or more sets of data are stored in the one or more data storage units; and
the one or more data storage units are kept in a dormant state;
one or more controllers located in the data mesh and in electronic communication with the data orchestrator and the one or more data storage units;
one or more user devices located in the data mesh and in electronic communication with the data orchestrator;
a data map located in the data mesh and in electronic communication with the data orchestrator;
wherein the data orchestrator is configured to implement one or more machine learning systems to:
identify a content of the one or more sets of data distributed across the one or more data storage units;
identify a pre-determined level of sensitivity for each of the one or more sets of data, wherein the pre-determined level of sensitivity indicates what credentials are required to access each of the one or more sets of data;
identify one or more locations where the one or more sets of data are distributed across the one or more data storage units;
identify one or more points of interest within the one or more sets of data, wherein the one or more points of interest are one or more pieces of data that have been pre-determined to have a higher probability of recognition by an accessor than data in the one or more sets of data other than the one or more points of interest;
populate the data map with the content of the one or more sets of data, the pre-determined level of sensitivity for each of the one or more sets of data, the one or more locations of the one or more sets of data, and the one or more points of interest within the one or more sets of data;
when the data orchestrator receives a request for one or more sets of data from an accessor:
receive credentials from the accessor;
look up in the data map to find one or more sets of data that meet the request from the accessor, and which are permitted to be shared based on the credentials from the accessor;
provide the credentials from the accessor to the one or more controllers positioned between the data orchestrator and the one or more data storage units;
receive clearance from the one or more controllers to access the one or more data storage units, wherein the one or more controllers wakes up the one or more data storage units from the dormant state; and
provide the credentials from the accessor to the one or more data storage units; and
in response to the request for one or more sets of data from the accessor, provide the accessor with an identified one or more sets of data which are permitted to be shared with the accessor based on the credentials from the accessor, the one or more locations associated with the one or more sets of data, and the one or more points of interest associated with the one or more sets of data.
